(19) United States
(12) Patent Application Publication
(10) Pub. No.: US 2010/0171076 A1
(43) Pub. Date: Jul. 8, 2010

(54) NEAR-INFRARED LIGHT-EMITTING PHOSPHOR NANOPARTICLES, METHOD FOR MANUFACTURING THE SAME, AND BIOLOGICAL SUBSTANCE LABELING AGENT EMPLOYING THE SAME

(75) Inventors: Naoko Furusawa, Tokyo (JP); Hideki Hoshino, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc., Tokyo (JP)

(21) Appl. No.: 12/663,574

(22) PCT Filed: May 22, 2008
(86) PCT No.: PCT/JP2008/059438

§ 371 Date: Dec. 8, 2009

(30) Foreign Application Priority Data
Jun. 13, 2007 (JP) 2007-156061

(51) Int. Cl. C09K 11/70

(52) U.S. Cl. 252/301.4 P; 428/402; 977/773

(57) ABSTRACT

Disclosed are near-infrared light-emitting phosphor nanoparticles with an extremely small particle size, which emit light with a high intensity of emission and which are suitable for a biological substance labeling agent, a method for manufacturing the same, and a biological substance labeling agent employing the same. The near-infrared light-emitting phosphor nanoparticles of the invention are near-infrared light-emitting phosphor nanoparticles with an average particle size of from 2 to 50 nm, which when excited by a near-infrared light with a wavelength in the range of from 700 to 900 nm, emit a near-infrared light with a wavelength in the range of from 700 to 2000 nm, the nanoparticles being characterized in that at least a part of the composition is represented by a specific formula.

### FIELD OF THE INVENTION

The present invention relates to near-infrared light-emitting phosphor nanoparticles, a method for manufacturing the same, and a biological substance labeling agent employing the same.

### TECHNICAL BACKGROUND

As a method for labeling a biological substance, a method has been studied which employs a biological substance labeling agent in which a molecule labeling agent is combined with a marker substance. When a phosphor material is used as a marker substance, there is problem in that light with a short wavelength in the ultraviolet region causes damage to cells. Therefore, a phosphor is required which is excited by, and emits, light with a long wavelength causing less damage.

In recent years, attention has been focused on in vivo light imaging in small animals. An optical device with which the target cells in a living body of small animals can be observed from outside without causing damage to the living body (noninvasive) has been sold by makers. This is one in which when phosphor material labeled with a marker, which is selectively located at the site in a living body to be observed, is injected into the living body and irradiated with excitation light from outside, emitted light are observed from an outside monitor.

In order to observe from outside light emitted on excitation of the phosphor material in the living body, it is necessary that the excitation light and emitted light pass through the living body. Ultraviolet light or visible light are absorbed by the living body and do hardly pass through the living body, which are undesirable. A light having a wavelength of not less than 1000 nm is likely to be absorbed by moisture and therefore, low in transmittance, which is undesirable. However, a near-infrared light wavelength region of from 700 to 1000 nm is called “optical window” or “spectral window”, and is a wavelength region of light with a specifically high living body transmittance. Therefore, a phosphor material is required, which is excited by, and emitting light with a wavelength falling within the above range.

A marker substance such as a conventional organic phosphor dye hitherto used in the above-described method has problem that great deterioration occurs on irradiation of excitation light and the lifetime is short. Further, such a substance is low in emission efficiency and insufficient in sensitivity.

In recent years, attention has been focused on a method which employs semiconductor nanoparticles as a marker substance. For example, a biological substance labeling agent has been studied in which a polymer having a polar functional group is physically or chemically adsorbed on or combined with, the surface of semiconductor nanoparticles (refer to Patent Document 1, for example). A biological substance labeling agent has been also studied in which an organic compound is combined with the surface of Si/SiO₂ type semiconductor nanoparticles (refer to Patent Document 2, for example).

However, the biological substance labeling agent employing these conventional semiconductor nanoparticles have problems in accuracy of emission, and the like, which are still unsolved.

Semiconductor nanoparticles disclosed together with their effects, for example, in Patent document 1, are (CdSe/ZnS type) semiconductor nanoparticles. Generally, particles with a size smaller than that of Bohr excitons called quantum dots have features that the band gap varies depending on the particle size, that is, emission light wavelength varies by changing the particle size of particles with the same composition. Such quantum dot phosphor materials have advantages that emission light wavelength can be freely varied by the size, however, they have defects that accuracy of size control has an influence on accuracy of emission light wavelength.

In recent years, near-infrared light-emitting phosphors, which emit light on irradiation of excitation light, are generally used as a latent image forming ink for security printing of credit cards or pre-paid cards used as a means for payment instead of cash. As the composition of those phosphors is known AB_{1-x-y}NdₓYb_{y}PO₄ (wherein A is at least one element selected from Li, Na, K, Rb and Cs; B is at least one element selected from Sc, Y, La, Ce, Gd, Lu, Ga, and In; and 0.05≦x≦0.999; 0.001≦y≦0.950; and x+y≦1.0) or AB_{1-x-y}NdₓYb₁₋ₓP₄O₁₂. These, when excited by a near-infrared light emitting diode (with a center wavelength of 880 nm), emit light with a wavelength of 980 nm, where both excitation light and emitted light pass through the optical window, and therefore, it has proved that these are preferred compositions. As the latent image forming ink, phosphor particles having a particle size of from several microns to submicron have been generally used, however, particles having a particle size of not more than 100 nm have not yet been used (refer to Patent Documents 1 and 2).

### Patent Document 1: Japanese Patent O.P.I. Publication No. 2003-329686

### Patent Document 2: Japanese Patent O.P.I. Publication No. 2005-172429

### Patent Document 3: Japanese Patent O.P.I. Publication No. 53-60888

### Patent Document 4: Japanese Patent O.P.I. Publication No. 5-295364

### DISCLOSURE OF THE INVENTION

### Problems to be Solved by the Invention

The present invention has been made in order to solve the above problems. An object of the invention is to provide near-infrared light-emitting phosphor nanoparticles with an extremely small particle size, which emit light with a high intensity of emission and which are suitable for a biological substance labeling agent, a method for manufacturing the same, and a biological substance labeling agent employing the same.

### Means for Solving the Above Problems

The present inventors have made an intensive study to solve the above problems. As a result, they have found that a method, which crystallizes a metal salt as particles having a particle size smaller than the intended one and calcines the particles without aggregation of the particles in the presence of a phosphoric acid flux according to a spray pyrolysis method, can form phosphor nanoparticles, which have a particle size of not more than 50 nm and a narrow particle size distribution of not more than 50% and which emit a light with high luminance, and have completed the invention.

The above object of the invention can be attained by the following constitution.

1. Near-infrared light-emitting phosphor nanoparticles with an average particle size of from 2 to 50 nm, which when excited by a near-infrared light with a wavelength in the range of from 700 to 900 nm, emits a near-infrared light with a wavelength in the range of from 700 to 2000 nm, wherein at least a part of the composition of the nanoparticles is represented by the following formula (1), (2) or (3),

M_{1-x-y}NdₓYb_{y}PO₄ Formula (1)

wherein M represents one element selected from Al, Bi, B, In, Ga, Y, Lu, Sc, Gd, La and Ce; and 0≦x≦0.5; 0≦y≦0.5; and 0<x+y<1,

D_{1-x-y}NdₓYb_{y}PO₄ Formula (2)

wherein D represents at least two elements selected from Al, Bi, B, In, Ga, Y, Lu, Sc, Gd, La and Ce; and 0≦x≦0.5; 0≦y≦0.5; and 0<x+y<1,

AB_{1-x-y}NdₓYb_{y}PO₄ Formula (3)

wherein A represents at least one element selected from an alkali metal and an alkali earth metal; B represents at least one element selected from Al, Bi, B, In, Ga, Y, Lu, Se, Gd, La and Ce; and 0≦x≦0.5; 0≦y≦0.5; and 0<x+y<1.

2. The near-infrared light-emitting phosphor nanoparticles of item 1 above, further comprising at least one of Pr and Tb as a coactivating agent.

3. The near-infrared light-emitting phosphor nanoparticles of item 1 or 2 above, wherein the surface of the nanoparticles is subjected to hydrophilizing treatment.

4. A method for manufacturing near-infrared light-emitting phosphor nanoparticles, the method comprising the steps of providing an aqueous solution of raw materials for the near-infrared light-emitting phosphor nanoparticles of any one of items 1 through 3 above; and crystallizing a metal ion as a sparingly soluble salt.

5. The method for manufacturing near-infrared light-emitting phosphor nanoparticles of item 4 above, the method further comprising the step of calcining a solution containing the sparingly soluble salt according to a spray•dry pyrolysis method.

6. The method for manufacturing near-infrared light-emitting phosphor nanoparticles of item 5 above, employing a phosphoric acid salt as a flux.

7. A biological substance labeling agent wherein the near-infrared light-emitting phosphor nanoparticles of any one of items 1 through 3 above are combined with a molecule labeling agent through an organic molecule.

8. The biological substance labeling agent of item 7 above, wherein the molecule labeling agent is a nucleotide chain.

9. The biological substance labeling agent of item 7 or 8 above, wherein the organic molecule, through which the near-infrared light-emitting phosphor nanoparticles are combined with a molecule labeling agent, is biotin or avidin.

### EFFECTS OF THE INVENTION

According to the constitution described above, the present invention can provide near-infrared light-emitting phosphor nanoparticles with an extremely small particle size, which emit light with a high intensity of emission and which are suitable for a biological substance labeling agent, a method for manufacturing the same, and a biological substance labeling agent employing the same.

### PREFERRED EMBODIMENT OF THE INVENTION

The near-infrared light-emitting phosphor nanoparticles of the invention are near-infrared light-emitting phosphor nanoparticles with an average particle size of from 2 to 50 nm and a particle size distribution of from 5 to 50t, which when excited by a near-infrared light with a wavelength in the range of from 700 to 900 nm, emit a near-infrared light with a wavelength in the range of from 700 to 2000 nm, the nanoparticles being characterized in that they have a composition represented by any of formulas (1) through (3) described above.

This characteristic is one which is common among claims 1 through 9.

In the invention, “nanoparticles” refer to particles having an average particle size (diameter) of less than 100 nm. In the invention, the preferred average particle size is from 2 to 50 nm and the preferred particle size distribution is from 5 to 50%.

Herein, the particle size distribution is defined by the following equation.

Particle size distribution=(Standard deviation of particle size/Average particle size)×100

Next, the invention and the constitution will be explained in detail.

### (Near-Infrared Light-Emitting Phosphor Nanoparticles)

The near-infrared light-emitting phosphor nanoparticles of the invention are characterized in that at least a part of the composition of the nanoparticles is represented by any of the following formulas (1) through (3).

M_{1-x-y}NdₓYb_{y}PO₄ Formula (1)

wherein M represents one element selected from Al, Bi, B, In, Ga, Y, Lu, Sc, Gd, La and Ce; and 0≦x≦0.5; 0≦y≦0.5; and 0<x+y<1,

D_{1-x-y}NdₓYb_{y}PO₄ Formula (2)

wherein D represents at least two elements selected from Al, Bi, B, In, Ga, Y, Lu, Sc, Gd, La and Ce; and 0≦x≦0.5; 0≦y≦0.5; and 0<x+y<1,

AB_{1-x-y}NdₓYb_{y}PO₄ Formula (3)

wherein A represents at least one element selected from an alkali metal and an alkali earth metal; B represents at least one element selected from Al, Bi, B, In, Ga, Y, Lu, Sc, Gd, La and Ce; and 0≦x≦0.5; 0≦y≦0.5; and 0<x+y<1.

The near-infrared light-emitting phosphor nanoparticles of the invention are required to have an average particle size of from 2 to 50 nm, in order to provide the feature of emitting a near-infrared light with a wavelength in the range of from 700 to 2000 nm when excited by a near-infrared light with a wavelength in the range of from 700 to 900 nm. It is preferred that the nanoparticles contain at least one of Pr and Tb as a coactivating agent.

The near-infrared light-emitting phosphor nanoparticles having an average particle size of from 2 to 50 nm, when the nanoparticles comprise 4 or more kinds of metal elements, or comprise a coactivating agent in an amount of not more than 10 atomic %, emit extremely high intensity of emission, as compared with particles manufactured by a conventional solid phase method, particles comprising three kinds of metal elements or particles containing no coactivating agent.

As raw material for manufacturing the near-infrared light-emitting phosphor nanoparticles of the invention, oxides or halides of various kinds of elements contained in formulas (1) through (3) can be used. Examples thereof include neodymium oxide, neodymium halide, ytterbium oxide, ytterbium halide, lanthanum oxide, lanthanum halide, yttrium oxide, yttrium halide, orthophosphoric acid, praseodymium chloride, and erbium chloride.

In the invention, the average particle size of the near-infrared light emitting phosphor nanoparticles of three dimensions should be determined, but the determination is difficult since the particles are too small, and practically, the average particle size of the nanoparticles of two dimensions is determined. It is preferred that the particles at various portions are photographed employing a transmission electron microscope (TEM) to obtain many electron micrographs, and an average thereof is determined. Accordingly, in the invention, the particle sizes of the sections of many particles in the electron micrographs photographed by TEM are measured, and the arithmetic average thereof is determined as an average particle size. Herein, a diameter of a circle having the same area as the measurement is defined as a particle size. The number of cluster particles to be photographed by TEM is preferably not less than 20, and more preferably 100.

### (Method for Manufacturing Near-Infrared Light-Emitting Phosphor Nanoparticles)

The near-infrared light emitting phosphor nanoparticles of the invention can be manufactured under appropriate conditions employing known conventional various methods.

In the invention, it is preferred that the manufacturing method comprises the step of providing an aqueous solution of raw materials for near-infrared light emitting phosphor nanoparticles and crystallizing a metal ion as a sparingly soluble salt. It is preferred that the manufacturing method further comprises the step of calcining a solution containing the sparingly soluble salt according to a spray dry•pyrolysis method.

### <Reaction Crystallization Method>

In the invention, it is preferred that the manufacturing method comprises the steps of providing an aqueous solution of raw materials for near-infrared light emitting phosphor nanoparticles and crystallizing a metal ion as a sparingly soluble salt.

As minus ions forming a sparingly soluble salt in combination with rare earth metal ions, there are mentioned a hydroxyl ion, an oxalic acid ion and a phosphoric acid ion. Among these ions, a phosphoric acid ion is preferred in providing low solubility product.

As one example of methods crystallizing a metal ion as a sparingly soluble salt, there is a reaction crystallization method. The reaction crystallization method refers to a method employing crystallization phenomenon, in which a solution containing elements as raw materials for near-infrared light-emitting phosphor nanoparticles is mixed in a liquid phase to prepare a phosphor precursor. Herein, the crystallization phenomenon refers to phenomenon in which a solid phase crystallizes out from a liquid phase, when the state of a mixture varies due to change of physical or chemical condition such as cooling, evaporation, pH change or concentration or chemical reaction.

In the invention, a method of manufacturing the phosphor precursor according to the reaction crystallization method refers to a method employing a physical or chemical operation capable of inducing the crystallization phenomenon as described above.

A solvent used in the reaction crystallization method may be any as long as it can dissolve reaction raw materials, and water is preferred in that a degree of supersaturation can be easily controlled. When plural kinds of raw materials are used, addition of the raw materials may be carried out at the same time or in order, and an appropriate addition order of the raw materials can be determined based on activities of the materials.

The particle size of the sparingly soluble salt formed during reaction crystallization is determined by a degree of supersaturation, and high degree of supersaturation crystallizes small particles. A degree of supersaturation ρ is determined by a solute concentration C and a solute solubility Ce in a solution, and is represented by the following equation,

ρ=(C−Ce)/Ce

When the solute concentration C is constant, the solubility C is an element determining a degree of supersaturation. For example, zinc sulfide is considered to be a composition in which nanoparticles easily crystallize out, since it has a solubility product of 3×10⁻²², which is low, and therefore, has a high degree of supersaturation. Thus, in the crystallization reaction in which control of a degree of supersaturation is required, a mixing device is important. Because a degree of supersaturation is low under condition in which either positive ions or negative ions are excessively present due to localization of the ions during addition of the raw materials, resulting in dissolution of particles.

The present inventors have found that it is preferred to use a continuous mixing device as a method to solve the above problems. The continuous mixing device is one having a structure in which a phosphor raw material solution supplied from a first path and a phosphor raw material solution supplied from a second path are continuously collision-mixed to obtain a mixture solution, and the mixture solution is then continuously supplied to a third path where the mixture solution is retained at a Reynoldz number of 3000 for 0.001 seconds or more, and then continuously ejected from the third path. This device is an excellent device in that a degree of supersaturation can be kept constant during the addition, which is suitable to obtain phosphor nanoparticles.

The present inventors have found that particles are formed in a protective colloid such as gelatin, whereby aggregation of the particles is prevented, and nanoparticles, which have a small average particle size and a narrow particle size distribution are formed, and that when gelatin is used as a protective colloid, the formed phosphor emits light. As the protective colloid, there can be employed various kinds of polymeric compounds including natural and synthetic ones. Of these, the use of proteins is preferred.

Examples of proteins include gelatin, a water-soluble protein and a water-soluble glycoprotein. Specific examples thereof include albumin, egg albumin, casein, soy bean protein, synthetic proteins and genetically-modified proteins.

Gelatins include, for example, a lime-treated gelatin and an acid-treated gelatin. These gelatins may be used in combination. There may be also used a hydrolysis or enzymolysis product of these gelatins.

The protective colloid need not be formed of a single constituent but may be formed of a mixture of various kinds of binders. Specifically, there may be used a graft polymer of the gelatin described above with other polymers.

The average molecular weight of the protective colloid is preferably not less than 10,000, more preferably from 10,000 to 300,000, and still more preferably from 10,000 to 30,000.

A protective colloid may be added to at least one of the raw material solutions or all of the raw material solutions. The particle size of the precursor can be controlled by an addition amount of a protective colloid or by the addition rate of a reaction solution.

Formation of the phosphor precursor in the presence of a protective colloid prevents aggregation of precursor particles, resulting in reduced particle size of the phosphor precursor.

### <Spray Dry•Pyrolysis Method>

In the invention, it is preferred that a manufacturing method is used which comprises the step of providing an aqueous solution or suspension (dispersion) containing a sparingly soluble salt obtained in the reaction crystallization method described above, followed by drying and calcination. A manufacturing method is especially preferred which employs spray dry•pyrolysis of the aqueous solution or suspension (dispersion). According to this method, near-infrared light-emitting phosphor nanoparticles with a reduced average particle size emitting light with high intensity of emission can be relatively easily manufactured.

The reason is considered to be due to the fact that the elements constituting the phosphor nanoparticles, which are contained in a solution, are uniformly present in liquid droplets. Intensity of emission is higher as the particle size becomes smaller. Raw materials in spatially narrow portions are required to be uniformly mixed. Particularly when many kinds of raw materials are employed and/or raw materials in a slight amount of not more than 8 atomic % are employed, intensity of emission increases.

A spray dry•pyrolysis method is generally a method which atomizes a raw material solution employing a nozzle or ultrasonic wave to form minute liquid droplets, evaporates the solvent of the liquid droplets at high temperature to obtain solid particles, and pyrolyzes the solid particles at high temperature to obtain minute particles (hereinafter also referred to simply as particles) of intended compounds.

The particle size of the phosphor can be controlled by the size of the liquid droplets and a concentration of the raw material solution.

During the manufacture according to the spray dry•pyrolysis method described above, simultaneous atomization of a phosphoric acid flux as a phosphor raw material can prevent size increase resulting from aggregation of particles. The phosphor particles enclosed in the flux are collected. Therefore, even if the particles, collected after spray and calcination aggregate, the particles inside the fluxes are present in a single state, although the fluxes are adhered to each other. This shows that nanoparticles can be obtained by dissolution or removal of the fluxes.

The addition amount of a phosphoric acid salt as a raw material of the flux is preferably 1.5 to 10 times of the stoichiometric proportion. A small amount of the flux causes fusion of the phosphor particles. A large amount of the flux lowers a concentration of raw materials used and requires long reaction time, resulting in lowering of yield.

In the invention, as a device used for manufacture according to a spray dry•pyrolysis method, a known conventional spray calcination device can be used. For example, a spray calcination device disclosed in Japanese Patent O.P.I. Publication No. 2003-277745 can be used. When such a device is used, it is preferred that the temperature during drying is adjusted to be from 100 to 300° C., and the temperature during calcination to be from 500 to 1000° C.

It is preferred that phosphor nanoparticles obtained employing the device described above are immersed in hot water for a given period, and then washed with an acid solution such as a nitric acid solution.

### [Hydrophilization of Near-Infrared Light-Emitting Phosphor Nanoparticle Assembly]

The near-infrared light-emitting phosphor nanoparticles described above are obtained as an assembly. The surface of the assembly is generally hydrophobic. For example, when the assembly is used as a biological substance labeling agent, the assembly exhibits poor water dispersibility, resulting in aggregation of particles which is problematic. Therefore, the surface of the nanoparticles is preferably hydrophilized. As a hydrophilization method, there is, for example, a method wherein after oleophilic groups on the surface of the particles are removed with pyridine, etc, a surface modifier is chemically and/or physically combined with the particle surface. As the surface modifier, those containing a carboxyl group or an amino group as a hydrophilic group are preferably used. Typical examples thereof include mercaptopropionic acid, mercaptoundecanoic acid, and aminopropane thiol.

Specifically, for example, 10⁻⁵ g of near-infrared light-emitting phosphor nanoparticles are dispersed in 10 ml of pure water dissolving 0.2 g of mercaptoundecanoic acid, and stirred at 40° C. for 10 minutes to surface-treat the shell surface, whereby the surface of the near-infrared light-emitting phosphor nanoparticles is modified with a carboxyl group.

### [Biological Substance Labeling Agent]

The biological substance labeling agent of the present invention is obtained by combining the above hydrophilized near-infrared light-emitting phosphor nanoparticles with a molecule labeling agent via an organic molecule.

### <Molecule Labeling Agent>

In the invention, the molecule labeling substance of the biological substance labeling agent specifically is combined with and/or reacted with, a targeted biological substance, whereby the biological substance labeling agent can label the biological substance.

Examples of the molecule labeling substance include a nucleotide chain, an antibody, an antigen and cyclodextrin.

### <Organic Molecule>

In the biological substance labeling agent according to the present invention, the hydrophilized near-infrared light-emitting phosphor nanoparticles are combined with the molecule labeling agent through an organic molecule. The organic molecule is not specifically limited, as long as it is one capable of combining with the near-infrared light-emitting phosphor nanoparticles and with the molecule labeling agent. Preferred examples of the organic molecule include proteins such as albumin, myoglobin and casein, and one kind of protein, avidin which is used in combination with biotin. A bonding manner through which the nanoparticles are combined with the molecule labeling agent via the organic molecule as describes above, although not specifically limited, includes covalent bonding, ionic bonding, hydrogen bonding, coordination bonding, physical adsorption or chemical adsorption. From the viewpoint of bonding stability, bonding featuring a strong bonding force such as covalent bonding is preferred.

Specifically, when the near-infrared light-emitting phosphor nanoparticles are hydrophilized with mercaptoundecanoic acid, avidin and biotin can be used as the organic molecules. In this case, the carboxyl group of the hydrophilized nanoparticles is suitably covalently combined with avidin, which is then selectively combined with biotin, the biotin being further combined with a biological substance labeling agent to obtain a biological substance labeling agent.

### EXAMPLES

The present invention will be explained in detail in the following examples, but is not limited thereto. In the following examples, near-infrared light-emitting phosphor nanoparticles are referred to simply as phosphor.

### Example 1

### Manufacturing Method of Phosphor 1

Ammonium dihydrogenphosphate of 402 g and 15 g of gelatin with a molecular weight of 20000 were dissolved in pure water to make Solution A of 250 ml.

Erbium chloride of 5.39 g, 22.35 g of ytterbium chloride, 24.53 g of lanthanum chloride and 15 g of gelatin with a molecular weight of 20000 were dissolved in pure water to make Solution B of 250 ml.

The solutions A and B were mixed at 60° C. in a continuous mixer to obtain Solution C.

The Solution C was subjected to drying at 200° C. and calcination at 700° C. employing a spray dry•pyrolysis•calcination device disclosed in Japanese Patent O.P.I. Publication Nos. 2003-277745 to obtain powder. The resulting powder was immersed in 80° C. hot water for 10 hours, then cooled, washed with a 1N nitric acid solution, and washed with water to prepare Phosphor 1.

The composition of the resulting phosphor was found to be La_{0.5}Yb_{0.4}Er_{0.1}P₃O₉

### Example 2

Phosphor 2 was prepared in the same manner as in Example 1, except that 36.55 g of erbium chloride, 354.69 g of ytterbium chloride, and 15 g of gelatin with a molecular weight of 20000 were dissolved in pure water to make a solution of 250 ml, and the solution was used as the Solution B.

The composition of the resulting Phosphor was found to be Yb_{0.9}Er_{0.1}P₃O₉.

### Example 3

### Manufacturing Method of Phosphor 3

Phosphor 3 was prepared in the same manner as in Example 1, except that 5.39 g of erbium chloride, 22.35 g of ytterbium chloride, 24.03 g of lanthanum chloride, 0.25 g of praseodymium chloride and 15 g of gelatin with a molecular weight of 20000 were dissolved in pure water to make a solution of 250 ml, and the solution was used as the Solution B.

### Comparative Example 1

Erbium oxide of 7.53 g, 32.47 g of ytterbium oxide, 31.91 g of lanthanum oxide and 80.52 g of ammonium hydrogenphosphate were sufficiently mixed as powder raw materials, incorporated in a capped alumina crucible, heated from room temperature to 700° C. at a constant rate of temperature increase in two hours in an electric furnace, and then subjected to calcination at 700° C. for 6 hours. Immediately after calcination, the crucible was taken out from the electric furnace and cooled in atmospheric air. Subsequently, the crucible was charged with water and subjected to ultrasonic wave irradiation at an output power of 500 W for one hour. The resulting mixture was immersed in 80° C. hot water for 10 hours, then cooled, washed with a 1N nitric acid solution and washed with water to prepare Phosphor 4.

The composition of the resulting Phosphor was found to be La_{0.5}Yb_{0.4}Er_{0.1}P₃O₉.

### Comparative Example 2

Phosphor 5 was prepared in the same manner as in Comparative Example 1, except that 7.34 g of erbium oxide, 71.25 g of ytterbium oxide, and 80.52 g of ammonium hydrogenphosphate were mixed as powder raw materials.

The composition of the resulting Phosphor was found to be Yb_{0.9}Er_{0.1}P₃O₉

The phosphors 1, 2 and 3 obtained above were observed employing a TEM. The particle size of 100 particles was measured and an average thereof was determined as an average particle size. The particle size distribution was determined by the following equation.

Particle size distribution=(Standard deviation of particle size/Average particle size)×100

The phosphors were excited by irradiation of 810 nm excitation light, and emission spectra of emitted light were observed. Intensity of emission was represented in terms of relative intensity of emission to intensity of emission peak of Phosphor 5 being set at 100%.

The results are shown in Table 1.

TABLE 1

| | Relative | Average | | Particle | | |
|---|---|---|---|---|---|---|
| | Intensity | Particle | | Size | | |
| | of Emission | Size | | Distribution | Composition | Remarks |
| Phosphor 1 | 108% | 36 | nm | 32% | La_{0.5}Yb_{0.4}Er_{0.1}P₃O₉ | Inventive |
| Phosphor 2 | 105% | 42 | nm | 24% | Yb_{0.9}Er_{0.1}P₃O₉ | Inventive |
| Phosphor 3 | 112% | 32 | nm | 34% | La_{0.5}Yb_{0.4}Er_{0.1}P₃O₉: Pr | Inventive |
| Phosphor 4 | 98% | 2.1 | μm | 210% | La_{0.5}Yb_{0.4}Er_{0.1}P₃O₉ | Comparative |
| Phosphor 5 | 100% | 3.3 | μm | 165% | Yb_{0.9}Er_{0.1}P₃O₉ | Comparative |

The intensity of emission of Phosphor 5 was set at 100%.

All the phosphors had a wavelength providing emission maximum in the range of from 980 to 990 nm.

As is apparent from the above, the inventive phosphors had an average particle size in the range of from 20 to 40 nm and a particle size distribution of not more than 500. That is, the present invention can provide near-infrared light-emitting phosphor nanoparticles with an extremely small particle size, which emit light with a high emission intensity and which are suitable for a biological substance labeling agent, and provide a manufacturing method thereof.

### Example 4

An aqueous dispersion containing 1.0×10⁻⁵ mol/liter of Phosphor 1 was added with 25 mg of avidin and stirred at 40° C. for 10 minutes to prepare avidin-conjugate nanoparticles.

A biotinylated oligonucleotide having a known base sequence was mixed with the above-obtained avidin-conjugate nanoparticle solution while stirring to prepare a nanoparticle-labeled oligonucleotide.

The above labeled oligonucleotide was dropped onto a DNA chip tightly holding oligonucleotides having various base sequences, followed by washing. Only the spot of an oligonucleotide having a base sequence complementary to that of the labeled oligonucleotide of these oligonucleotides emitted light on irradiation of a 810 nm excitation light.

The above result shows that labeling of oligonucleotide with the nanoparticles has been confirmed. That is, the result shows that the invention can provide a biological substance labeling agent employing the near-infrared light-emitting phosphor nanoparticles of the invention.

1. Near-infrared light-emitting phosphor nanoparticles with an average particle size of from 2 to 50 nm, which when excited by a near-infrared light with a wavelength in the range of from 700 to 900 nm, emits a near-infrared light with a wavelength in the range of from 700 to 2000 nm, wherein at least a part of the composition of the nanoparticles is represented by the following formula (1), (2) or (3),
M_{1-x-y}NdₓYb_{y}PO₄ Formula (1)
wherein M represents one element selected from Al, Bi, B, In, Ga, Y, Lu, Sc, Gd, La and Ce; and 0≦x≦0.5; 0≦y≦0.5; and 0<x+y<1,
D_{1-x-y}NdₓYb_{y}PO₄ Formula (2)
wherein D represents at least two elements selected from Al, Bi, B, In, Ga, Y, Lu, Sc, Gd, La and Ce; and 0≦x≦0.5; 0≦y≦0.5; and 0<x+y<1,
AB_{1-x-y}NdₓYb_{y}PO₄ Formula (3)
wherein A represents at least one element selected from an alkali metal and an alkali earth metal; B represents at least one element selected from Al, Bi, B, In, Ga, Y, Lu, Sc, Gd, La and Ce; and 0≦x≦0.5; 0≦y≦0.5; and 0<x+y<1.

2. The near-infrared light-emitting phosphor nanoparticles of claim 1, further comprising at least one of Pr and Tb as a coactivating agent.

3. The near-infrared light-emitting phosphor nanoparticles of claim 1, wherein the surface of the nanoparticles is subjected to hydrophilizing treatment.

4. A method for manufacturing near-infrared emitting phosphor nanoparticles, the method comprising the steps of:
providing an aqueous solution of raw materials for the near-infrared light-emitting phosphor nanoparticles of claim 1; and
crystallizing a sparingly soluble metal salt from the aqueous solution.

5. The method for manufacturing near-infrared light-emitting phosphor nanoparticles of claim 4, the method further comprising the step of:
calcining the crystallized metal salt.

6. The method for manufacturing near-infrared light-emitting phosphor nanoparticles of claim 5, employing a phosphoric acid salt as a flux.

7. A biological substance labeling agent wherein the near-infrared light-emitting phosphor nanoparticles of claim 1 are combined with a molecule labeling agent through an organic molecule.

8. The biological substance labeling agent of claim 7, wherein the molecule labeling agent is a nucleotide chain.

9. The biological substance labeling agent of claim 7, wherein the organic molecule, through which the near-infrared light-emitting phosphor nanoparticles are combined with a molecule labeling agent, is biotin or avidin.

10. The biological substance labeling agent of claim 8, wherein the organic molecule, through which the near-infrared light-emitting phosphor nanoparticles are combined with a molecule labeling agent, is biotin or avidin.
